(19) United States
(12) Patent Application Publication
(10) Pub. No.: US 2010/0073225 A1
(43) Pub. Date: Mar. 25, 2010

(54) TWO-WAY RADIO HANDHELD TRANSCEIVER CAPABLE OF WIRELESS RECEPTION AND TRANSMISSION OF LOCATION INFORMATION ASSOCIATED THEREWITH, AND SYSTEM INCLUDING THE SAME

(75) Inventor: Hymen Fan, Chung Ho City (TW)

Correspondence Address: OSHA LIANG L.L.P., TWO HOUSTON CENTER, 909 FANNIN, SUITE 3500, HOUSTON, TX, 77010, US

(73) Assignee: WINTECRONICS LTD., Chung Ho City, Taipei Hsien (TW)

(21) Appl. No.: 12/390,090

(22) Filed: Feb. 20, 2009

(30) Foreign Application Priority Data
Sep. 22, 2008 (TW) 097136312

(51) Int. Cl. G01S 1/00

(52) U.S. Cl. 342/357.1

(57) ABSTRACT

A system includes a location information-providing device and a two-way radio handheld transceiver. The location information-providing device is operable so as to transmit a location signal, which contains predetermined location information that is associated with an installed location thereof and that is stored therein, wirelessly. The two-way radio handheld transceiver is operable so as to receive the location signal transmitted by the location information-providing device, so as to store therein the predetermined location information contained in the location signal received thereby, and so as to transmit the predetermined location information stored therein wirelessly.

### CROSS-REFERENCE TO RELATED APPLICATION

This application claims priority of Taiwanese Application No. 097136312, filed on Sep. 22, 2008.

### BACKGROUND OF THE INVENTION

1. Field of the Invention

This invention relates to a two-way radio handheld transceiver, more particularly to a two-way radio handheld transceiver capable of wireless reception and transmission of location information associated therewith.

2. Description of the Related Art

A conventional two-way radio handheld transceiver, a.k.a., walkie-talkie, that is capable of receiving location information associated therewith from a global positioning system (GPS) receiver is well known in the art.

The conventional GPS-enabled two-way radio handheld transceiver is disadvantageous in that, since GPS signals typically cannot be received indoor, e.g., within a building, location information associated therewith cannot be continuously provided thereto by the GPS receiver.

### SUMMARY OF THE INVENTION

Therefore, the object of the present invention is to provide a system that permits a two-way radio handheld transceiver to receive location information associated therewith both indoor and outdoor.

According to an aspect of the present invention, a system comprises at least one location information-providing device and a two-way radio handheld transceiver. The location information-providing device stores therein predetermined location information associated with an installed location thereof, and is operable so as to generate a location signal, which contains the predetermined location information stored therein, and so as to transmit the location signal generated thereby wirelessly. The two-way radio handheld transceiver is operable so as to receive the location signal transmitted by the location information-providing device, so as to store therein the predetermined location information contained in the location signal received thereby, and so as to transmit the predetermined location information stored therein wirelessly.

According to another aspect of the present invention, a location information-providing device comprises a memory unit, a processing unit, and a transceiver unit. The memory unit stores therein predetermined location information associated with an installed location of the location information-providing device. The processing unit is coupled to the memory unit, and is operable so as to generate a location signal, which contains the predetermined location information stored in the memory unit. The transceiver unit is coupled to the processing unit, and is operable so as to transmit the location signal generated by the processing unit wirelessly.

According to yet another aspect of the present invention, a two-way radio handheld transceiver comprises a receiver module and a transceiver module. The receiver module includes a transceiver unit, a processing unit, and a memory unit. The transceiver unit is adapted to receive a location signal wirelessly, which contains predetermined location information associated with the two-way radio handheld transceiver. The processing unit is coupled to the transceiver unit, and is operable so as to extract the predetermined location information from the location signal received by the transceiver unit. The memory unit is coupled to the processing unit, and stores therein the predetermined location information extracted by the processing unit. The transceiver module is coupled to the receiver module, and is operable so as to transmit the predetermined location information stored in the memory unit wirelessly.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of the preferred embodiment of a system according to this invention;

FIGS. 2 and 3 are block diagrams illustrating a location information-providing device and a two-way radio handheld transceiver of the preferred embodiment, respectively; and

FIGS. 4 to 6 are flow charts of the preferred embodiment of a method for tracking a location of a two-way radio handheld transceiver to be implemented using the system in FIG. 1.

### DETAILED DESCRIPTION OF THE PREFERRED EMBODIMENT

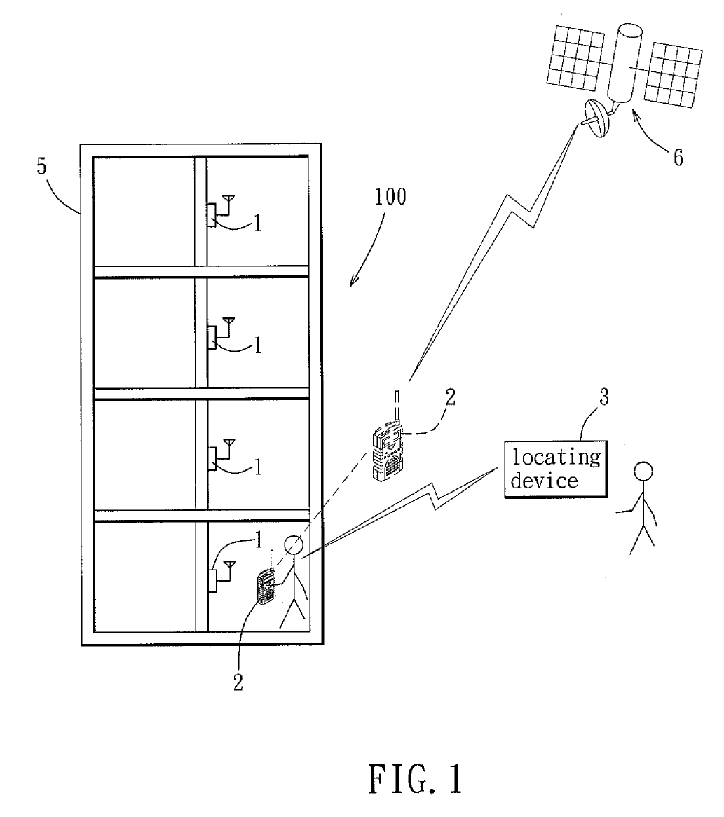

Referring to FIG. 1, the preferred embodiment of a system 100 according to this invention is shown to include a plurality of location information-providing devices 1, a two-way radio handheld transceiver 2, and a locating device 3.

The location information-providing devices 1 are installed in different locations, such as floors of a building 5.

Since the location information-providing devices 1 are identical in structure and operation, only one of the location information-providing devices 1 will be described herein.

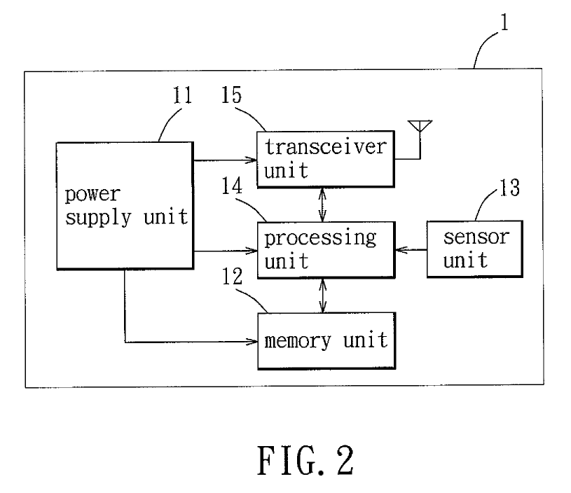

With further reference to FIG. 2, the location information-providing device 1 includes a power supply unit 11, a memory unit 12, a processing unit 14, and a transceiver unit 15.

The power supply unit 11 is connected to and supplies electrical power to the memory unit 12, the processing unit 14, and the transceiver unit 15. In this embodiment, the power supply unit 11 includes an alternating current (AC) to direct current (DC) converter (not shown) and is adapted to be connected to an AC commercial power source (not shown).

In an alternative embodiment, the power supply unit 11 includes a DC-to-DC converter (not shown) and is adapted to receive therein a battery unit (not shown).

The memory unit 12 stores therein predetermined location information associated with an installed location of the location information-providing device 1. As an example, when the location information-providing device 1 is installed at suite three in a seventh floor of an xyz building, the predetermined location information stored in the memory unit 12 may include the code “xyz-7-3”.

The processing unit 14 is connected to the memory unit 12, and is operable so as to generate a location signal, which contains the predetermined location information stored in the memory unit 12.

The transceiver unit 15 is connected to the processing unit 14, and is operable so as to transmit the location signal generated by the processing unit 14 wirelessly to the two-way radio handheld transceiver 2.

In this embodiment, the processing unit 14 generates and the transceiver unit 15 transmits the location signal in response to a location request from the two-way radio handheld transceiver 2.

In an alternative embodiment, the processing unit 14 generates and the transceiver unit 15 transmits the location signal automatically. In such a case, the transceiver unit 15 may be implemented using a conventional transmitter.

It is noted that the transceiver unit 15 of each of the location information-providing devices 1 is a short-range transceiver unit, operates within an industrial, scientific, and medical (ISM) frequency band, and has a transmit/receive power that ranges between 0.01 Watt and 0.1 Watt. As such, interference among the location information-providing devices 1 may be avoided.

The location information-providing device 1 further includes a sensor unit 13 that is connected to the processing unit 14, and that is operable so as to detect conditions of the surroundings of the location information-providing device 1, e.g., temperature and humidity, and so as to generate sensor information, which includes the conditions of the surroundings detected thereby. The sensor unit 13 is further operable so as to detect a status of an electrical power thereof, which is also included in the sensor information generated thereby.

The memory unit 12 further stores therein the sensor information generated by the sensor unit 13.

The location signal generated by the processing unit 14 further contains the sensor information stored in the memory unit 12.

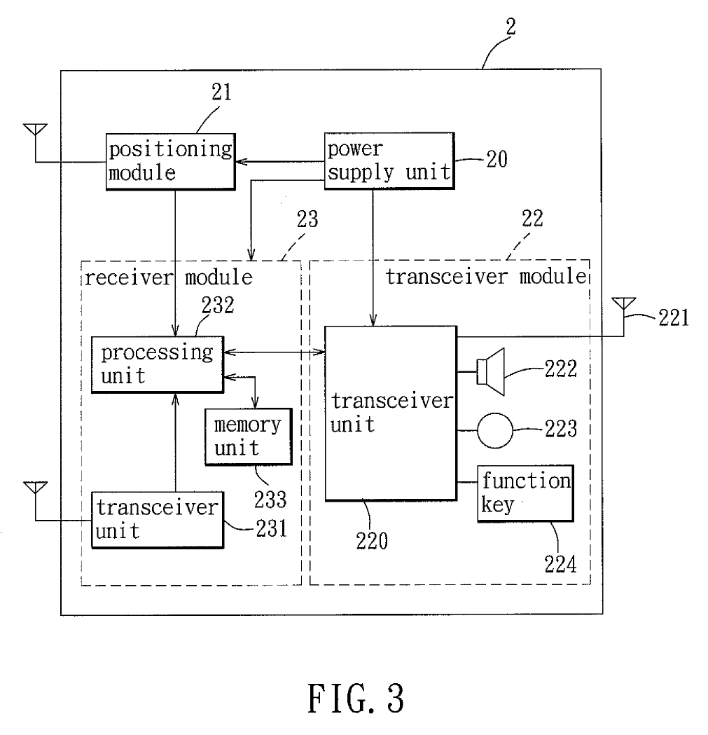

With further reference to FIG. 3, the two-way radio handheld transceiver 2 includes a power supply unit 20, a receiver module 23, a positioning module 21, and a transceiver module 22.

The power supply unit 20 is connected to and supplies electrical power to the receiver module 23, the positioning module 21, and the transceiver module 22.

The receiver module 23 includes a processing unit 232, and a transceiver unit 231 and a memory unit 233, each of which is connected to the processing unit 232. The transceiver unit 231 is operable so as to receive the location signal transmitted by the transceiver unit 15 of the location information-providing device 1. The processing unit 232 is operable so as to extract the predetermined location information and the sensor information contained in the location signal received by the transceiver unit 231, and so as to store the predetermined location information and the sensor information extracted thereby in the memory unit 233.

In this embodiment, the transceiver unit 15 of the location information-providing device 1 is a bluetooth-compliant transceiver unit, and the transceiver unit 231 of the receiver module 23 of the two-way radio handheld transceiver 2 is a bluetooth-compliant transceiver unit.

In an alternative embodiment, the transceiver unit 15 of the location information-providing device 1 is an infrared-compliant transceiver unit, and the transceiver unit 231 of the receiver module 23 of the two-way radio handheld transceiver 2 is an infrared-compliant transceiver unit.

The positioning module 21 is connected to the processing unit 232, and is operable so as to receive a global positioning signal (GPS) signal from a GPS 6, and so as to generate location information of the two-way radio handheld transceiver 2 based on the GPS signal received thereby.

The transceiver module 22 includes a transceiver unit 220 connected to the processing unit 232, and an antenna 221 connected to the transceiver unit 220. The transceiver unit 220 is operable so as to transmit via the antenna 221 the predetermined location information and the sensor information stored in the memory unit 233 or the location information generated by the positioning module 21 wirelessly.

In this embodiment, the processing unit 232 is operable in a location-transmitting mode, where the processing unit 232 determines a quality of the GPS signal received by the positioning module 21 from the location information generated by the positioning module 21 such that the transceiver unit 220 transmits the location information generated by the positioning module 21 when it is determined that the quality of the GPS signal received by the positioning module 21 exceeds a predetermined threshold, and such that the processing unit 232 sends the location request to the location information-providing device 1 via the transceiver unit 231 when it is determined thereby that the quality of the GPS signal received by the positioning module 21 does not exceed the predetermined threshold.

It is noted that transceiver unit 220 transmits the predetermined location information and/or the sensor information stored in the memory unit 233, or the location information generated by the positioning module 21 via a short-message service (SMS) in some embodiments of the invention.

The transceiver module 22 further includes a function key 224, a microphone 223, and a speaker 222, each of which is connected to the transceiver unit 220. The function key 224 is operable so as to actuate the transceiver unit 220 to transmit via the antenna 221 a voice signal detected by the microphone 223. The transceiver unit 220 is further operable so as to receive via the antenna 221 a signal, which is thereafter converted by the speaker 222 into an audible signal. In this embodiment, the transceiver module 22 may be an analog transceiver module, a digital transceiver module, a half-duplex transceiver module, or a full-duplex transceiver module.

It is noted that the transceiver unit 220 is capable of being actuated, such as through the function key 224, to transmit the predetermined location information and/or the sensor information stored in the memory unit 233 or the location information generated by the positioning module 21.

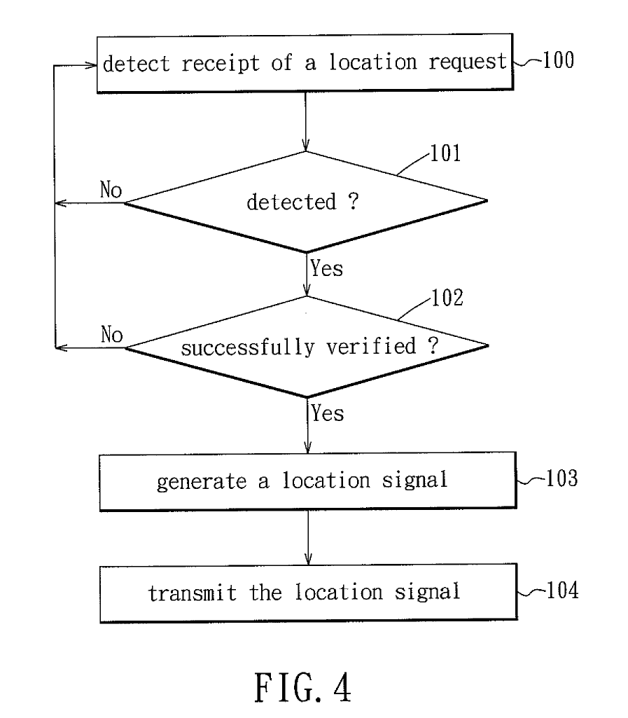

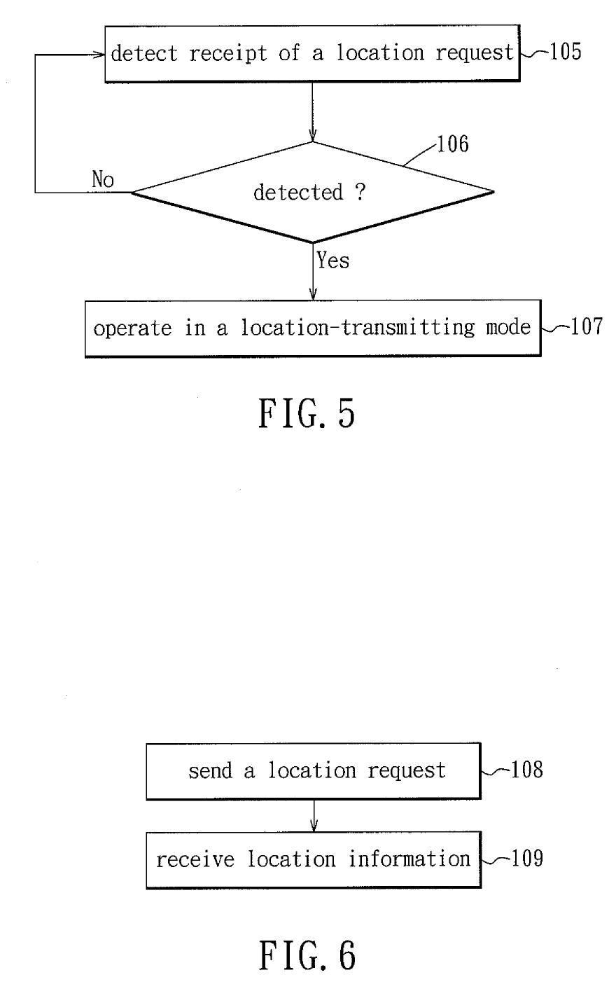

The preferred embodiment of a method for tracking a location of a two-way radio handheld transceiver 2 to be implemented using the aforementioned system 100 according to this invention will now be described with further reference to FIGS. 4 to 6.

In step 100, the processing unit 14 of the location information-providing device 1 detects receipt of a location request from the two-way radio handheld transceiver 2.

In step 101, when the receipt of the location request is detected in step 100, the flow proceeds to step 102. Otherwise, the flow goes back to step 100.

In step 102, when the processing unit 14 of the location information-providing device 1 successfully verifies the location request received in step 100, the flow proceeds to step 103. Otherwise, the flow goes back to step 100.

In this step, the processing unit 14 of the location information-providing device 1 verifies for example a password contained in the location request.

In step 103, the processing unit 14 of the location information-providing device 1 generates a location signal, which contains the predetermined location information stored in the memory unit 12 of the location information-providing device 1.

In step 104, the transceiver unit 15 of the location information-providing device 1 transmits the location signal generated in step 103 to the two-way radio handheld transceiver 2.

The method further includes the following steps:

105) the processing unit 232 of the receiver module 23 of the two-way radio handheld transceiver 2 detects receipt of a location request from the locating device 3;

106) when the receipt of the location request is detected in step 105, the flow proceeds to step 107. Otherwise, the flow goes back to step 105; and

107) the processing unit 232 of the receiver module 23 of the two-way radio handheld transceiver 2 operates in the location-transmitting mode.

The method further includes the following steps:

108) the locating device 3 sends a location request to the two-way radio handheld transceiver 2; and

109) the locating device 3 receives the SMS transmitted by the two-way radio handheld transceiver 2.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A system, comprising:
at least one location information-providing device storing therein predetermined location information associated with an installed location thereof, and operable so as to generate a location signal, which contains the predetermined location information stored therein, and so as to transmit the location signal generated thereby wirelessly; and
a two-way radio handheld transceiver operable so as to receive the location signal transmitted by said location information-providing device, so as to store therein the predetermined location information contained in the location signal received thereby, and so as to transmit the predetermined location information stored therein wirelessly.

2. The system as claimed in claim 1, wherein said location information-providing device is further operable so as to detect a condition of the surroundings thereof, and the location signal generated thereby further contains the condition of the surroundings detected thereby,
said two-way radio handheld transceiver being further operable so as to transmit the condition of the surroundings contained in the location signal received thereby wirelessly.

3. The system as claimed in claim 1, wherein said location information-providing device generates and transmits the location signal automatically.

4. The system as claimed in claim 1, wherein said two-way radio handheld transceiver is further operable so as to send a location request to said location information-providing device, and said location information-providing device generates and transmits the location signal in response to the location request from said two-way radio handheld transceiver.

5. The system as claimed in claim 4, wherein said two-way radio handheld transceiver is adapted to receive a global positioning system (GPS) signal, and is further operable so as to generate location information thereof based on the GPS signal received thereby, and so as to transmit the location information generated thereby wirelessly.

6. The system as claimed in claim 5, wherein said two-way radio handheld transceiver is further operable in a location-transmitting mode, where said two-way radio handheld transceiver determines a quality of the GPS signal received thereby such that said two-way radio handheld transceiver transmits the location information generated thereby when it is determined that the quality of the GPS signal received thereby exceeds a predetermined threshold, and such that said two-way radio handheld transceiver sends the location request to said location information-providing device when it is determined that the quality of the GPS signal received thereby does not exceed the predetermined threshold.

7. The system as claimed in claim 6, further comprising a locating device operable so as to receive the location information of said two-way radio handheld transceiver and the predetermined location information transmitted by said two-way radio handheld transceiver and so as to send a location request to said two-way radio handheld transceiver,
said two-way radio handheld transceiver operating in the location-transmitting mode in response to the location request from said locating device.

8. A location information-providing device, comprising:
a memory unit storing therein predetermined location information associated with an installed location of said location information-providing device;
a processing unit coupled to said memory unit, and operable so as to generate a location signal, which contains the predetermined location information stored in said memory unit; and
a transceiver unit coupled to said processing unit, and operable so as to transmit the location signal generated by said processing unit wirelessly.

9. The location information-providing device as claimed in claim 8, further comprising a sensor unit coupled to said processing unit, and operable so as to detect a condition of the surroundings of said location information-providing device, and the location signal generated by said processing unit further contains the condition of the surroundings detected by said sensor unit.

10. The location information-providing device system as claimed in claim 8, wherein said processing unit generates and said transceiver unit transmits the location signal automatically.

11. The location information-providing device as claimed in claim 8, wherein said transceiver unit is adapted to receive a location request,
said processing unit generating and said transceiver unit transmitting the location signal in response to the location request received by said transceiver unit.

12. A two-way radio handheld transceiver, comprising:
a receiver module including
a transceiver unit adapted to receive a location signal wirelessly, which contains predetermined location information associated with said two-way radio handheld transceiver,
a processing unit that is coupled to said transceiver unit, and that is operable so as to extract the predetermined location information from the location signal received by said transceiver unit, and
a memory unit that is coupled to said processing unit, and that stores therein the predetermined location information extracted by said processing unit; and
a transceiver module coupled to said receiver module, and operable so as to transmit the predetermined location information stored in said memory unit wirelessly.

13. The two-way radio handheld transceiver as claimed in claim 12, further comprising a positioning module adapted to receive a global positioning system (GPS) signal, and operable so as to generate location information of said two-way radio handheld transceiver based on the GPS signal received thereby,
said transceiver module being further operable so as to transmit the location information generated by said positioning module wirelessly.

14. The two-way radio handheld transceiver as claimed in claim 13, wherein said processing unit is operable in a location-transmitting mode, where said processing unit determines a quality of the GPS signal received by said positioning module such that said transceiver module transmits the location information generated by said positioning module when it is determined that the quality of the GPS signal received by said positioning module exceeds a predetermined threshold, and such that said transceiver unit of said receiver module sends a request for the location signal when it is determined that the quality of the GPS signal received by said positioning module does not exceed the predetermined threshold.

15. The two-way radio handheld transceiver as claimed in claim 12, wherein said transceiver module is one of an analog transceiver module, a digital transceiver module, a half-duplex transceiver module, and a full-duplex transceiver module.
